(19) United States
(12) Patent Application Publication
(10) Pub. No.: US 2002/0138603 A1
(43) Pub. Date: Sep. 26, 2002

(54) Systems and methods for updating IP communication service attributes

(76) Inventor: Kurt W. Robohm, Leesburg, VA (US)

Correspondence Address: WORLDCOM, INC., TECHNOLOGY LAW DEPARTMENT, 1133 19TH STREET NW, WASHINGTON, DC, 20036, US

(21) Appl. No.: 10/097,865

(22) Filed: Mar. 15, 2002

Related U.S. Application Data
(60) Provisional application No. 60/276,923, filed on Mar. 20, 2001.
(60) Provisional application No. 60/276,953, filed on Mar. 20, 2001.
(60) Provisional application No. 60/276,954, filed on Mar. 20, 2001.
(60) Provisional application No. 60/276,955, filed on Mar. 20, 2001.

(51) Int. Cl. G06F 15/173; G06F 15/16; H04Q 11/00; H04L 12/16

(52) U.S. Cl. 709/223; 709/227; 370/259

(57) ABSTRACT

A system updates service attributes associated with an Internet Protocol (IP) communications network. The system includes a network interface, an operational data store, and a redirect server. The network interface receives at least one update to one of the service attributes from a user via a data network and forwards the at least one update to the operational data store. The operational data store stores the at least one update and forwards the at least one update to the redirect server. The redirect server stores the at least one update so as to make the at least one update available in substantially real time.

### RELATED APPLICATION

This application claims priority under 35 U.S.C. §119(e) based on U.S. Provisional Application Serial Nos. 60/276,923, 60/276,953, 60/276,954, and 60/276,955, all filed Mar. 20, 2001, the disclosures of which are incorporated herein by reference.

### FIELD OF THE INVENTION

The present invention relates generally to communications systems and, more particularly, to an operational support system that allows for communication service attributes to be updated in substantially real time.

### BACKGROUND OF THE INVENTION

Telecommunications service providers continually increase the number of services and products they offer to customers. A recent trend, for example, is a desire to offer broadband, wireless, and Internet services. As competition increases, service providers must provide an increased level of support for these advanced data services while keeping costs down.

Service providers also desire the ability to allow users (e.g., system administrators, engineers, and customers) to modify attributes associated with these advanced data services and to implement these modifications in substantially real time. By way of example, an attribute may relate to how Voice over Internet Protocol (VoIP) calls are routed to a customer Conventionally, changes to telecommunication services required human intervention and could take days or weeks before the changes took effect.

Accordingly, there is a need in the art for an operational support system that allows users to modify service attributes associated with an IP communications network such that the modifications are available in substantially real time.

### SUMMARY OF THE INVENTION

Systems consistent with the principles of this invention address this and other needs by providing systems and methods that allow users to make changes to telecommunication services in substantially real time.

In an implementation consistent with the present invention, a system that updates service attributes associated with an Internet Protocol (IP) communications network is provided. The system includes a network interface, an operational data store, and a redirect server. The network interface receives at least one update to one of the service attributes from a user via a data network and forwards the update to the operational data store. The operational data store stores the update and forwards the update to the redirect server. The redirect server stores the update so as to make the update available in substantially real time.

In another implementation consistent with the present invention, a method for providing IP communications network services is disclosed. The method includes providing a web-based interface to a user, where the web-based interface allows the user to update service attributes associated with the IP communications network. The method further includes receiving a change to a service attribute from the user, transferring the service attribute change from the operational data store to a redirect server that is associated with the IP communications network, storing the service attribute change at the redirect server so that the change is made available in substantially real time, and processing at least one call to the user based on the service attribute change.

### BRIEF DESCRIPTION OF THE DRAWINGS

The accompanying drawings, which are incorporated in and constitute a part of this specification, illustrate an embodiment of the invention and, together with the description, explain the invention. In the drawings,

FIG. 1 illustrates an exemplary system in which systems and methods, consistent with the present invention, may be implemented;

FIG. 2 illustrates an exemplary configuration of a user device of FIG. 1 in an implementation consistent with the present invention;

FIG. 3 illustrates an exemplary configuration of the operational support system of FIG. 1 in an implementation consistent with the present invention;

FIG. 4 illustrates an exemplary configuration of the process management system of FIG. 3 in an implementation consistent with the present invention;

FIG. 5 illustrates an exemplary functional block diagram of the process management system of FIG. 3 in an implementation consistent with the present invention;

FIG. 6 illustrates an exemplary configuration of the voice portal unit of FIG. 3 in an implementation consistent with the present invention;

FIG. 7 illustrates an exemplary configuration of the web center of FIG. 3 in an implementation consistent with the present invention;

FIG. 8 illustrates an exemplary configuration of the Internet Protocol Communications (IPCOM) unit of FIG. 3 in an implementation consistent with the present invention;

FIG. 9 illustrates an exemplary configuration of the very high performance backbone network service unit of FIG. 3 in an implementation consistent with the present invention;

FIG. 10 illustrates an exemplary process for configuring/updating service attributes associated with an IP communications network over a data network in an implementation consistent with the present invention;

FIG. 11 illustrates an exemplary login screen consistent with the present invention; and

FIGS. 12-21 illustrate exemplary screens that may be provided to the user by the network interface in an implementation consistent with the present invention.

### DETAILED DESCRIPTION

The following detailed description of implementations consistent with the present invention refers to the accompanying drawings. The same reference numbers in different drawings may identify the same or similar elements. Also, the following detailed description does not limit the invention. Instead, the scope of the invention is defined by the appended claims and equivalents.

Implementations consistent with the present invention provide an operational support system that allows users to modify service attributes associated with an IP communications network via a web-based interface. The modifications made by the user are made available in substantially real time.

### Exemplary System

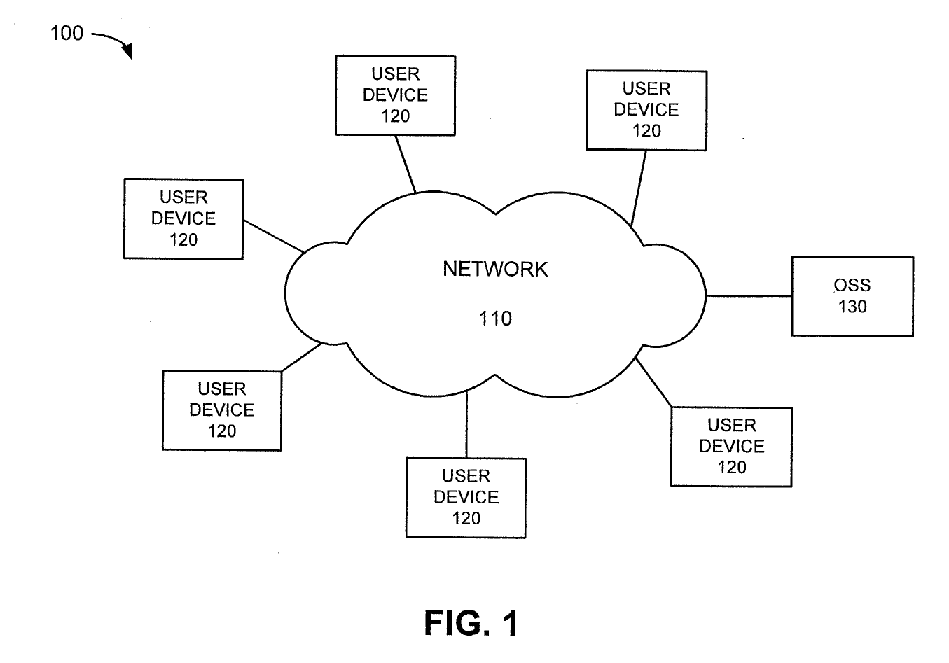

FIG. 1 illustrates an exemplary system 100 in which systems and methods, consistent with the present invention, may be implemented. In FIG. 1, system 100 includes a network 110 that interconnects a group of user devices 120 and an operational support system (OSS) 130. It will be appreciated that a typical system may include more or fewer devices than illustrated in FIG. 1. Moreover, system 100 may include additional devices (not shown) that aid in the transfer, processing, and/or reception of data.

The network 110 may include, for example, the Internet, an intranet, a local area network (LAN), a metropolitan area network (MAN), a wide area network (WAN), a public switched telephone network (PSTN), and/or some other similar type of network. In fact, the network 110 may include any type of network or combination of networks that permits routing of information from a particular source to a particular destination.

The user devices 120 may include a type of computer system, such as a mainframe, minicomputer, or personal computer, a type of telephone system, such as a POTS telephone or a session initiation protocol (SIP) telephone, and/or some other similar type of device that is capable of transmitting and receiving information to/from the network 110. The user device 120 may connect to the network via any conventional technique, such as a wired, wireless, or optical connection.

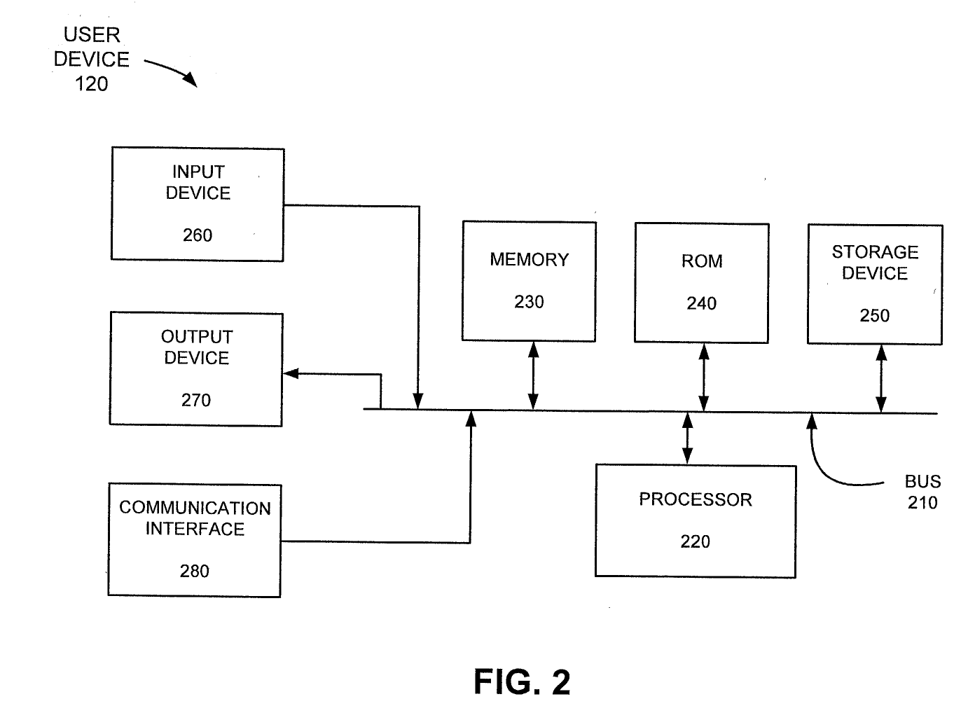

FIG. 2 illustrates an exemplary configuration of a user device 120 of FIG. 1 in an implementation consistent with the present invention. In FIG. 2, the user device 120 includes a bus 210, a processor 220, a memory 230, a read only memory (ROM) 240, a storage device 250, an input device 260, an output device 270, and a communication interface 280. The bus 210 may include one or more conventional buses that permit communication among the components of the user device 120.

The processor 220 may include any type of conventional processor or microprocessor that interprets and executes instructions. In one implementation consistent with the present invention, the processor 220 executes the instructions to cause a web browser to be displayed to an operator of the user device 120. As will be described in more detail below, the operator may access and modify attributes associated with the services provided by the OSS 130 via this web browser.

The memory 230 may include a random access memory (RAM) or another type of dynamic storage device that stores information and instructions for execution by the processor 220. The memory 230 may also be used to store temporary variables or other intermediate information during execution of instructions by processor 220.

The ROM 240 may include a conventional ROM device and/or another type of static storage device that stores static information and instructions for the processor 220. The storage device 250 may include a magnetic disk or optical disk and its corresponding drive and/or some other type of magnetic or optical recording medium and its corresponding drive for storing information and/or instructions.

The input device 260 may include any conventional mechanism or combination of mechanisms that permits an operator to input information to the user device 120, such as a keyboard, a mouse, a microphone, a pen, a biometric input device, such as voice recognition device, etc. The output device 270 may include any conventional mechanism or combination of mechanisms that outputs information to the operator, including a display, a printer, a speaker, etc.

The communication interface 280 may include any transceiver-like mechanism that enables the user device 120 to communicate with other devices and/or systems, such as OSS 130. For example, the communication interface 280 may include a modem or an Ethernet interface to a network.

Returning to FIG. 1, the OSS 130 provides the infrastructure for integrating data from traditional telephony services and applications with advanced data application platforms. Through OSS 130, customers, using, for example, user device 120, may manage, configure, and provision traditional telephony and advanced data services in real time, obtain real time billing information, and generate reports using a rules-centric middleware core. In one embodiment, a customer may perform these functions through a single point of entry using an Internet accessible web interface.

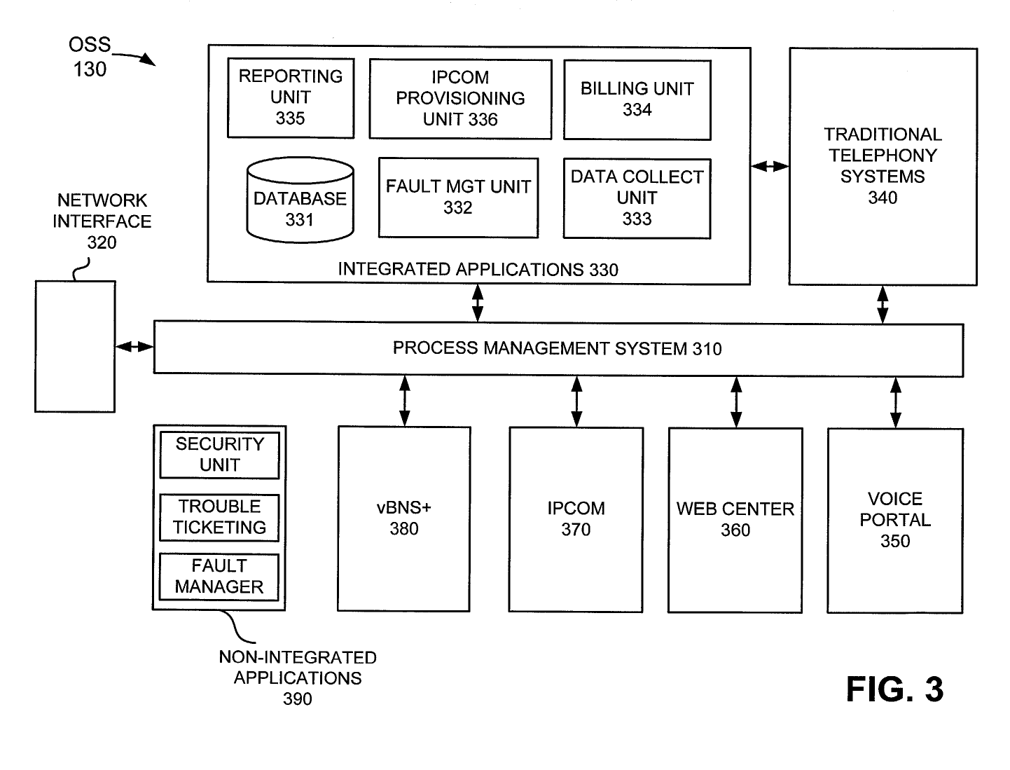

FIG. 3 illustrates an exemplary configuration of the OSS 130 of FIG. 1 in an implementation consistent with the present invention. As illustrated, the OSS 130 includes a process management system 310, a network interface 320, a group of integrated applications 330, a group of traditional telephony systems 340, a voice portal unit 350, a web center unit 360, an IPCOM unit 370, a very high performance backbone network service (vBNS+) unit 380, and a group of non-integrated applications 390. It will be appreciated that the OSS 130 may include other components (not shown) that aid in receiving, processing, and/or transmission of data.

The process management system 310 acts as the backbone to the OSS 130 by providing graphical process automation, data transformation, event management, and flexible connectors for interfacing with OSS components. In one implementation consistent with the present invention, the process management system 310 uses a Common Object Request Broker Architecture (CORBA) based publish-and-subscribe messaging middleware to integrate the different components of the OSS 130. Other techniques for integrating the different components of the OSS 130 may alternatively be used, such as eXtensible Markup Language (XML) or Enterprise JavaBeans (EJB). The process management system 310 may, for example, be implemented using Vitria Technology Inc.'s BusinessWare software system.

The network interface 320 provides a graphical user interface that allows users (e.g., customers, engineers, account teams, and the like) to access the components of the OSS 130. The network interface 320 may include commercial off the shelf (COTS) software or hardware packages, such as Siteminder® by Netegrity, Inc. and/or iPlanet™ by Sun Microsystems, Inc., custom software or hardware, or a combination of custom software/hardware and COTS software/hardware.

Via the network interface 320, customers may, for example, request that service be connected or disconnected, monitor or change network or user settings, obtain reports, and perform e-billing, account management, and trouble reporting and tracking functions in a real time manner. The network interface 320 may, for example, allow engineers to submit transactions to control and configure network elements and services in a real time manner. The network interface 320 may, for example, allow account teams to manage account creations and cancellations, generate sub-accounts from master accounts, access current account data, and access historical account data. As will be described in additional detail below, the network interface 320 allows the service attributes associated with the IPCOM unit 370 to be configured and controlled remotely, such as over the Internet.

The network interface 320 authenticates users and controls actions that authenticated users are allowed to execute in the OSS 130. In one implementation consistent with the present invention, the network interface 320 allows users access to the components of the OSS 130 via a single sign-on technique. This single sign-on eliminates the need for users to sign in (or authenticate themselves) in order to access different components of the OSS 130. Once authenticated, users may access those components of the OSS 130 to which they have been provided authorization.

The integrated applications 330 may include, for example, a database 331, a fault management unit 332, a data collection unit 333, a billing unit 334, a reporting unit 335, and an IPCom Provisioning unit 336. The database 331 may include one or more separate databases for storing data. In one implementation, the database 331 includes a data warehouse, an operational data store, and a lightweight directory access protocol (LDAP) directory server. The data warehouse acts as a repository for service order, account, usage, and performance data. In one implementation, the data warehouse may be implemented as a relational database management system (RDBMS) based system.

The operational data store temporarily the most recent version of service and engineering attributes/parameters that should be acted upon in the OSS 130. The operational data store also stores authentication and authorization data. This data defines user's roles and privileges. Like the data warehouse, the operational data store may be a RDBMS based system.

The LDAP directory server stores similar information to that described above with respect to the operational data store, however, the LDAP directory server stores entries in a hierarchical, tree-like structure. As a result, the LDAP directory server provides a quick response to high volume lookup and/or search operations. Additional information regarding LDAP can be found in W. Yeong et al., “Lightweight Directory Access Protocol,” RFC 1777, March 1995, which is incorporated herein by reference.

The fault management unit 332 monitors and manages the overall operation of the OSS 130. The fault management unit 332 receives information from every device, computer and application in the OSS 130 via the process management system 310 and, in situations where a fault has been detected, may transmit trouble tickets identifying the fault to the appropriate system administrator.

The data collection unit 333 collects customer usage and performance data for the devices supported by the OSS 130, transforms the data, if necessary, and passes the data on to the appropriate device, such as the billing unit 334, the database 331, etc. In one implementation, the data collection unit 333 utilizes a hierarchical architecture, having a centralized manager that defines and manages collection and data transformation schemas. Individual, lower level gatherers interface with source targets.

The billing unit 334 receives customer usage and performance data from the data collection unit 333 and generates bills in a well-known manner based thereon. The billing unit 334 may be configured with a variety of rating rules and plans and may provide mechanisms to manage and create rating plans, as well as mechanisms for building revenue reports and generating billing reports. The rating rules may be customized based on a particular customer's requirements or generalized. The rating rules may include traditional telephony styled rating rules that include time-of-day, day-of-week, distance-based, flat rate, non-recurring, and recurring on a definably regular basis, such as weekly, bi-weekly, monthly, etc., ratings. In an exemplary implementation of the present invention, the billing unit 334 may also provide bonus points, airline miles, and other incentive items as part of the rules-based rating and billing service.

Billing unit 334 may provide revenue and billing reports to authorized parties. Billing unit 334 may allow customers to access previous invoices and view current charges not yet billed. In an exemplary implementation consistent with the present invention, billing unit 334 may transfer rated events and summary records into other billing and revenue systems. For example, billing unit 334 may receive and transfer billing information or event information to a legacy billing system (i.e., an existing billing system) that generates the actual bill. In alternative implementations, billing unit 334 may provide hard copy bills and/or provide electronic bills to a customer. In this implementation, billing unit 334 may be configured to perform electronic payment handling.

As customer orders and accounts are created or modified through normal business functions, the OSS 130 keeps the billing unit 334 up to date in a real time manner via the process management system 310. Authorized parties may also extract real time data from the billing unit 334.

The reporting unit 335 may interact with various components of the OSS 130, such as the database 331 and billing unit 334, to provide users (i.e., customers, engineers, and accountants) with the ability to obtain reports based on real time data. The reports may include, for example, billing reports, reports regarding the usage and/or performance of the network, etc.

The IPCom provisioning unit 336 allows for attributes associated with the IPCOM unit 370 to be updated. As will be described in detail below, the IPCom provisioning unit 336 may provide graphical user interface screens to a user via the network interface 320 to allow the user to add, delete, or update IP communications network service attributes.

The traditional telephony systems 340 may include one or more components that are typically used in a telecommunications network. In one implementation, the traditional telephony systems 340 include one or more legacy systems, such as an order entry system, provisioning system, billing system, and the like.

The voice portal unit 350 provides a variety of information services to subscribers. These services may include, for example, banking, brokerage, and financial services, travel and entertainment services, distribution and shipping services, insurance services, health and pharmaceutical services, manufacturing services, and the like. The voice portal unit 350 may store subscriber profiles to determine a subscriber's device preference (e.g., a cellular telephone, a personal digital assistant, a paging device, and the like) and may also track a subscriber's access to the services for billing purposes.

The web center 360 acts as a virtual call center by queuing, routing, and distributing communications from any first location to an appropriate agent at any second location. The web center 360 allows agents to handle multiple mediums (e.g., inbound telephone calls, faxes, emails, voicemail, VoIP transactions, etc.) via a single browser-based interface.

The IPCOM unit 370 may include one or more devices that provide VoIP services to subscribers. The subscribers may make and receive calls via an IP communications network using, for example, session initiation protocol (SIP) telephones. The IPCOM unit 370 may support the following exemplary services: follow me, call blocking, call forwarding, voice mail, conference calling, single line extension, call screening, quality of service, class of service, dial-plan restrictions, dynamic registration, secondary directory number, and call transfer. As described above, customers may set or change attributes associated with these features via the network interface 320.

The vBNS+ unit 380 provides the IP infrastructure for the IP communications network. The vBNS+ unit 380 may include a group of routers that route packets in the network. The non-integrated applications 390 may include, for example, a security unit, a trouble ticketing unit, and a fault manager. The security unit may include one or more firewalls for securing the network interface 320, telephone equipment (e.g., PBX, switch, and redirect server), and network operations. The trouble ticketing unit manages the issuance and resolution of trouble tickets. The fault manager monitors the hardware components of the OSS 130.

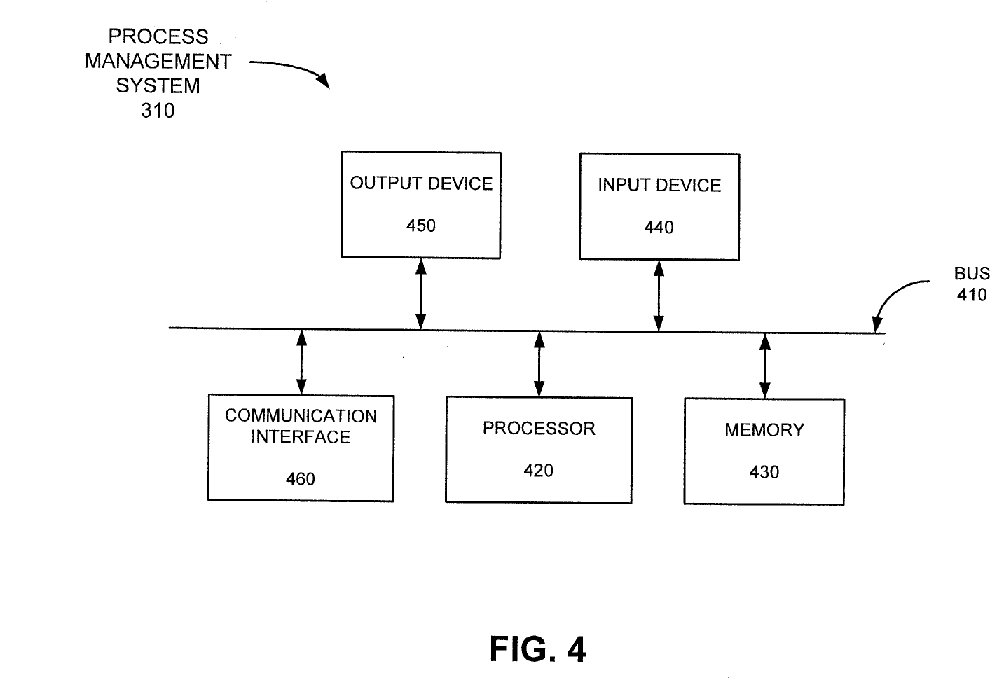

FIG. 4 illustrates an exemplary configuration of the process management system 310 of FIG. 3 in an implementation consistent with the present invention. As illustrated, the process management system 310 includes a bus 410, a processor 420, a memory 430, an input device 440, an output device 450, and a communication interface 460. The bus 410 permits communication among the components of the process management system 310.

The processor 420 may include any type of conventional processor or microprocessor that interprets and executes instructions. The memory 430 may include a RAM or another type of dynamic storage device that stores information and instructions for execution by the processor 420; a ROM or another type of static storage device that stores static information and instructions for use by the processor 420; and/or some type of magnetic or optical recording medium and its corresponding drive.

The input device 440 may include any conventional mechanism or combination of mechanisms that permits an operator to input information to the process management system 310, such as a keyboard, a mouse, a pen, a biometric mechanism, and the like. The output device 450 may include any conventional mechanism or combination of mechanisms that outputs information to the operator, including a display, a printer, a speaker, etc. The communication interface 460 may include any transceiver-like mechanism that enables the process management system 310 to communicate with other devices and/or systems, such as the network interface 320, integrated applications 330, traditional telephony systems 340, etc. via a wired, wireless, or optical connection.

Execution of the sequences of instructions contained in a computer-readable medium, such as memory 430, causes processor 420 to implement the functional operations described below. In alternative embodiments, hardwired circuitry may be used in place of or in combination with software instructions to implement the present invention. Thus, the present invention is not limited to any specific combination of hardware circuitry and software.

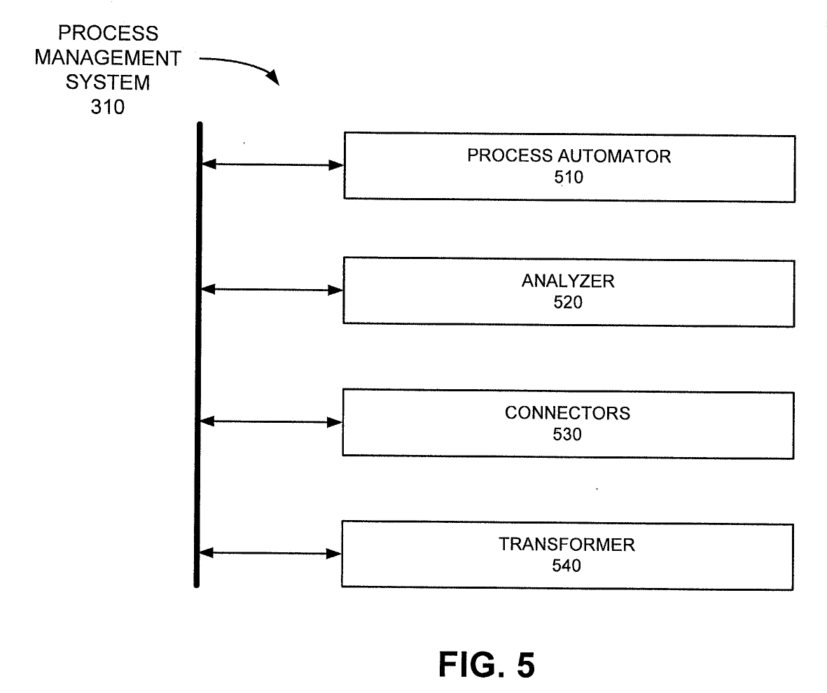

FIG. 5 illustrates an exemplary functional block diagram of the process management system 310 of FIG. 3 in an implementation consistent with the present invention. As illustrated, the process management system 310 includes a process automator 510, an analyzer 520, a group of connectors 530, and a transformer 540. It will be appreciated that the process management system 310 may include additional functional elements (not shown) that aid in the reception, processing, and/or transmission of data.

The processor automator 510 includes a modeling tool that allows event processing to be visually modeled by engineers and product development analysts. The process automator 510 can then execute these models to create an automated business process. The analyzer 520 provides on-going and real time monitoring of the components of the OSS 130. The analyzer 520 delivers reports, history, and trending on events processed through the process management system 310.

The connectors 530 include a group of customized rules that allows the components of the OSS 130 to interact and communicate with the process management system 310. A unique connector 530 may be established for each component in the OSS 130. As new components are added to the OSS 130, new connectors 530 are established to allow the new components to communicate with the existing components of the OSS 130. Once the connectors 530 have been established, the OSS components may communicate with the process management system 310 via standard messaging or through full publish/subscribe processing. The transformer 540 inspects data received by the connectors 530. The transformer 540 may also transform the data received by the connectors 530, if necessary, prior to the data being transferred on to its destination.

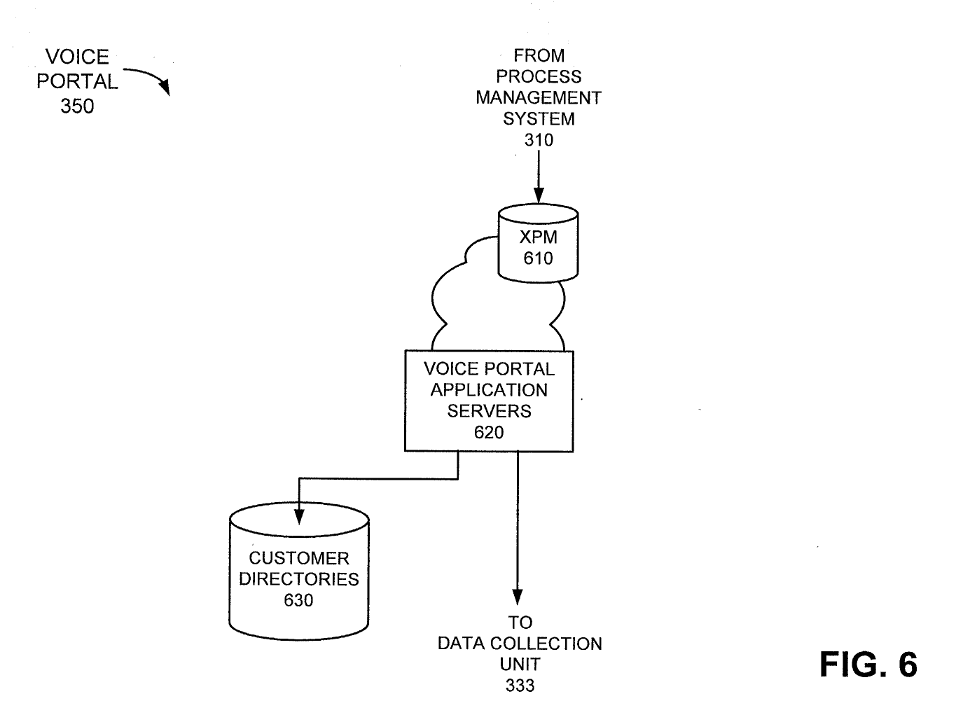

FIG. 6 illustrates an exemplary configuration of the voice portal unit 350 of FIG. 3 in an implementation consistent with the present invention. As illustrated, the voice portal unit 350 includes an extensible Program Management (XPM) unit 610, one or more voice portal application servers 620, and a customer directory database 630. The XPM unit 610 receives user profile information from the network interface 320 via the process management system 310 and stores this information for use by the voice portal application servers 620. The XPM unit 610 may also receive other information, such as information identifying the device(s) (e.g., personal digital assistant, cellular telephone, pager, etc.) by which the customer wishes to receive the service(s) provided.

The voice portal application servers 620 may include one or more servers that interact with the XPM unit 610 to provide, for example, banking, brokerage, and financial services, travel and entertainment services, distribution and shipping services, insurance services, health and pharmaceutical services, manufacturing services, and the like. Voice portal application servers 620 may also provide data collection unit 333 with information regarding what services are accessed and by whom. The data collection unit 333 may then pass this information on to the billing unit 334 for billing purposes. The voice portal application servers 620 may be located at the OSS 130 or distributed throughout the network 110. The customer directories 630 may store information relating to the services provided by the voice portal application servers 620. For example, the customer directories 630 may store stock quotes, current weather forecasts, real time sports scores, etc.

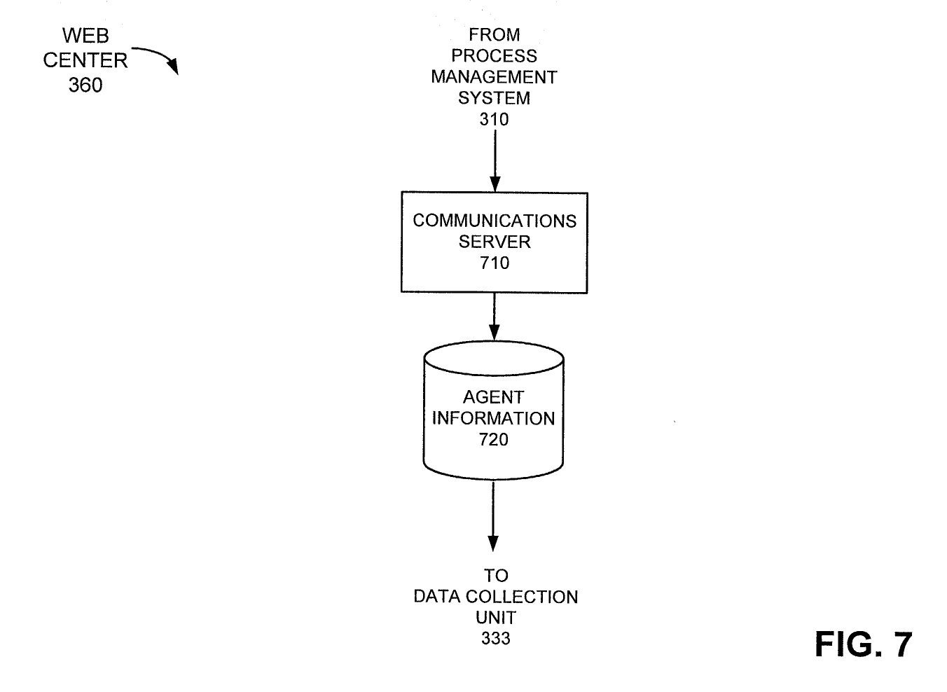

FIG. 7 illustrates an exemplary configuration of the web center 360 of FIG. 3 in an implementation consistent with the present invention. As illustrated, the web center 360 includes a communications server 710 and an agent information database 720. The communications server 710 queues, routes, and distributes communications from any first location to an appropriate agent at any second location. The communications server 710 may determine the appropriate agent based on data stored in the agent information database 720. The agent information database 720 may store agent activity information, the particular skills of the agents, and the like. Once a customer has utilized the services of the web center 360, the usage information may be transmitted to the data collection unit 333 and then to the billing unit 334 for billing. Users may, via the network interface 320, provision new services, such as order a toll free number, and/or create new accounts at the web center 360.

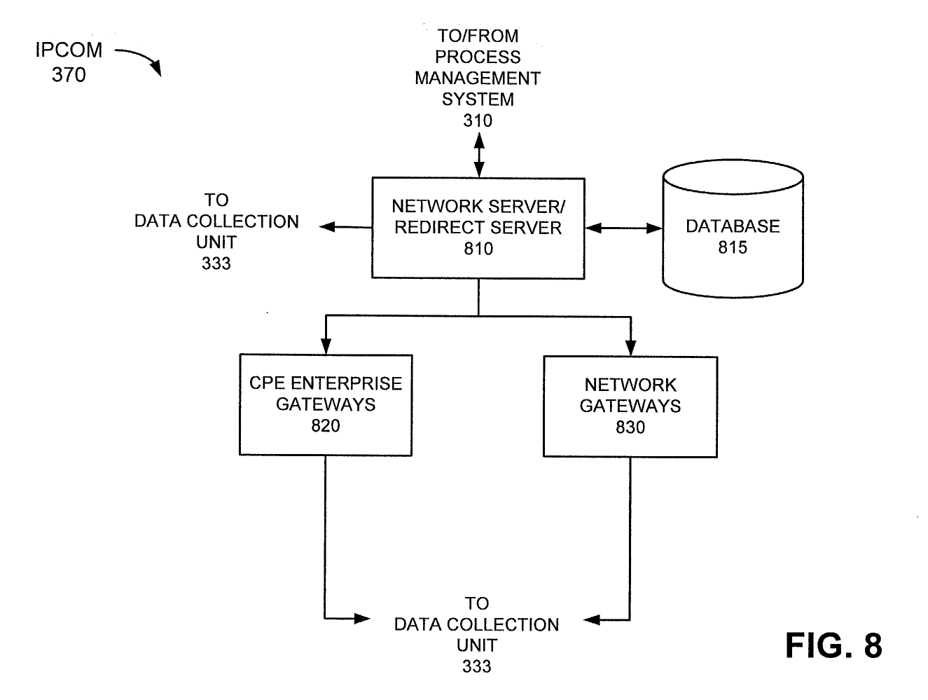

FIG. 8 illustrates an exemplary configuration of the IPCOM unit 370 of FIG. 3 in an implementation consistent with the present invention. As illustrated, the IPCOM unit 370 includes a network server/redirect server 810, CPE enterprise gateways 820, and network gateways 830. The network server/redirect server 810 may include one or more servers that process calls made over the IP communications network based on data stored in an associated database 815. The database 815 may store data relating to call processing (e.g., information identifying the device by which the subscriber wishes to receive the call, network configuration information, etc.), subscriber profiles (e.g., subscriber identifiers), and network-supported features. The network server/redirect server 810 may direct calls to the appropriate gateway 820 or 830 based on this data. The network-supported features may include, for example, follow me, call blocking, call forwarding, voice mail, conference calling, single line extension, call screening, quality of service, class of service, dial-plan restrictions, dynamic registration, secondary directory number, and call transfer. As will be described in detail below, a subscriber may change attributes of these network-supported features and other network-related attributes using the network interface 320.

The CPE enterprise gateways 820 may include one or more gateways for linking customer systems to the IP communications network. The CPE enterprise gateways 820 may, for example, connect to a customer's PBX and convert time division multiplexed (TDM) voice data into VoIP packets and voice signaling into SIP messages. The network gateways 830 include one or more gateways for linking the IP communications network to the PSTN in a well-known manner. The CPE enterprise gateways 820 and network gateways 830 track customer access and transmit this customer access data to the data collection unit 333 for billing purposes.

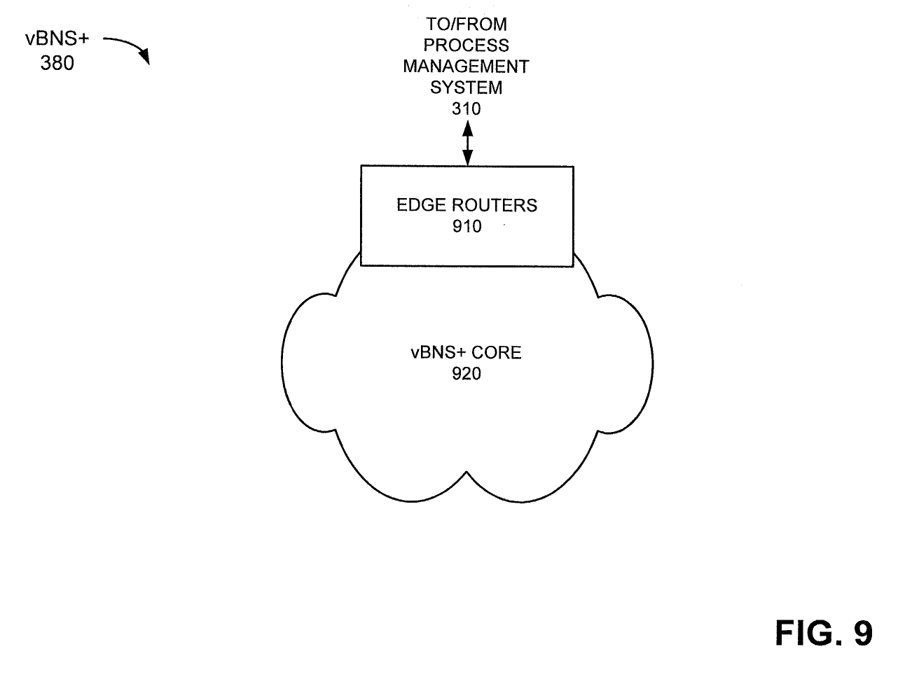

FIG. 9 illustrates an exemplary configuration of the vBNS+unit 380 of FIG. 3 in an implementation consistent with the present invention. As illustrated, the vBNS+ unit 380 includes a group of edge routers 910 that route packets to/from the vBNS+ core network 920. The edge routers 910 may connect to the network server/redirect server 810, network gateways 830, customer's CPE equipment, other routers in the IPCom network, directly to SIP telephones, etc. The edge routers 910 may be configured or updated via the network interface 320. The vBNS+ core 920 may include one or more core routers for routing packets between edge routers 910.

The foregoing description of the OSS 130 provides an overview of the configuration of the OSS 130. A more detailed description of the present invention is provided below.

### Exemplary Processing

Some of the products and services supported by the OSS 130 enable various users (e.g., customers, engineers, accounting personnel, order entry personnel, internal support staff members, etc.) to submit modifications to attributes associated with services provided by the OSS 130. It is important that these changes be available in substantially real time. The present invention is directed to systems and methods for configuring and controlling service attributes associated with the IP communications network via the network interface 320.

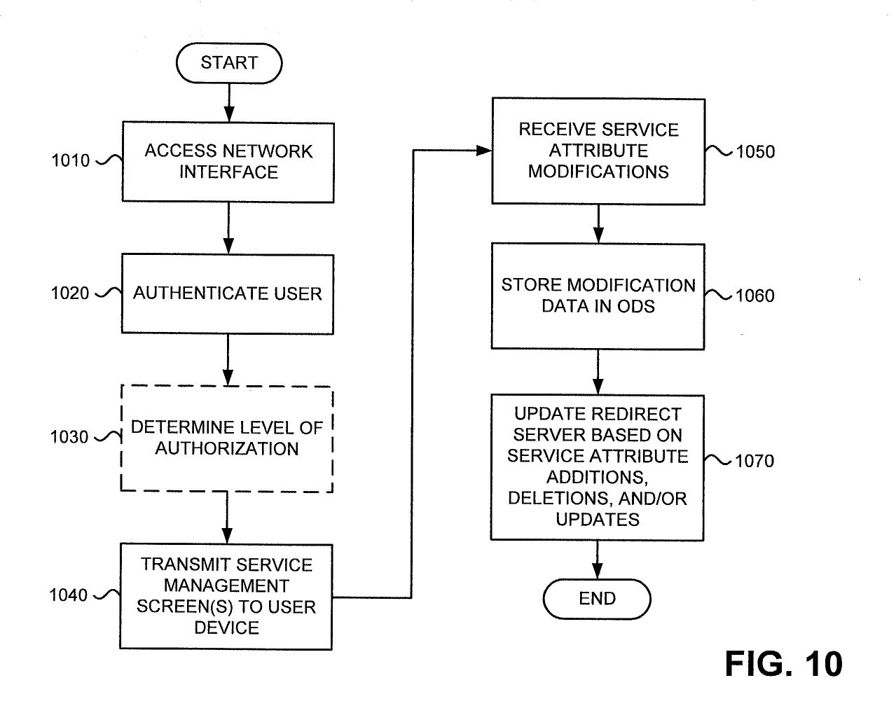

FIG. 10 illustrates an exemplary process for configuring/updating service attributes associated with an IP communications network over a data network in an implementation consistent with the present invention. Processing may begin with a user (e.g., a customer, an engineer, an accounting person, etc.) establishing a connection with the network interface 320 [act 1010]. The user may, for example, accomplish this via any conventional Internet connection by entering a link or address, such as a uniform resource locator (URL), associated with the network interface 320. In alternative implementations, the user may establish a direct connection with the network interface 320. In each of these scenarios, the network interface 320 may then transmit a login screen to the user in order to authenticate the user [act 1020].

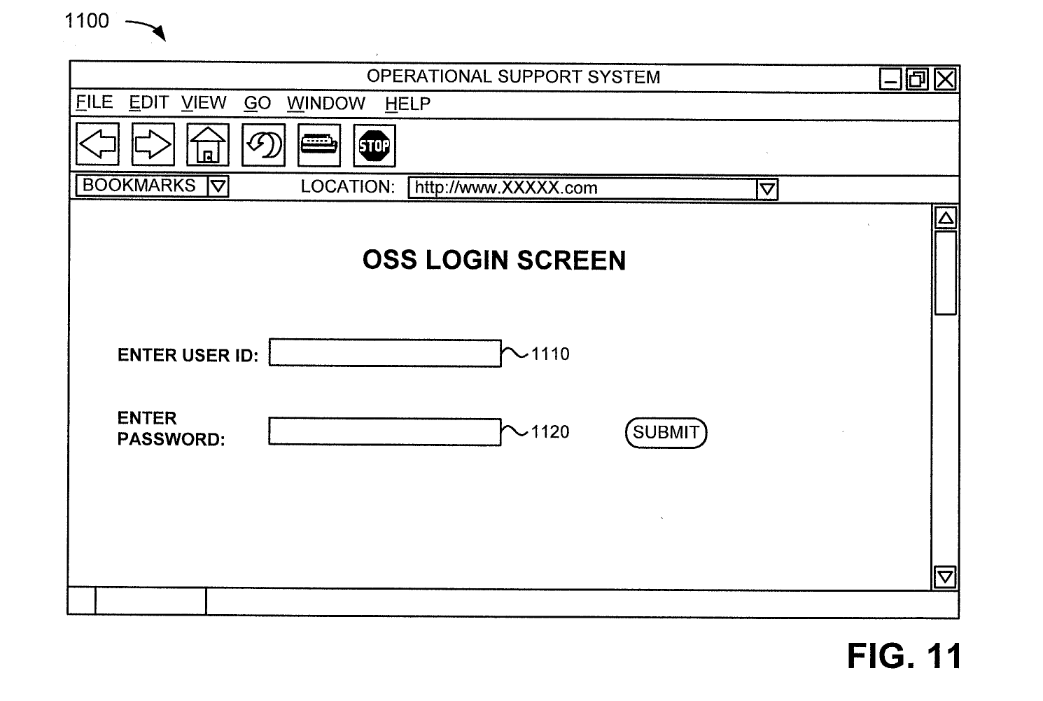

FIG. 11 illustrates an exemplary login screen 1100 consistent with the present invention. As illustrated, the login screen 1100 prompts the user to enter an identifier (ID) 1110 and password 1120. The identifier may be, for example, an e-mail address or some other unique identifier associated with the user.

The user may enter an ID and password in a well-known manner via the user device 120. The user device 120 may then transmit the user ID and password to the network interface 320. The network interface 320 may authenticate the user by, for example, comparing the user's ID and password to authorized identifiers and passwords [act 1020].

Once authenticated, the network interface 320 may optionally determine the level of authorization with which the user is associated [act 1030]. The OSS 130 may, for example, grant engineers a higher level of authorization (i.e., permit access to a greater number of components of the OSS 130) than customers.

It is assumed hereafter that the user wishes to make changes to service attributes associated with the IP communications network, such as attributes associated with the following exemplary services: follow me, call blocking, call forwarding, voice mail, conference calling, single line extension, call screening, quality of service, class of service, dial-plan restrictions, dynamic registration, secondary directory number, and call transfer. The network interface 320 may transmit service management screen(s) to the user device 120 to allow the user to modify service attributes associated with the IP communications network [act 1040]. As described above, the service management screen(s) may be provided to the network interface 320 via the IPCom provisioning unit 336.

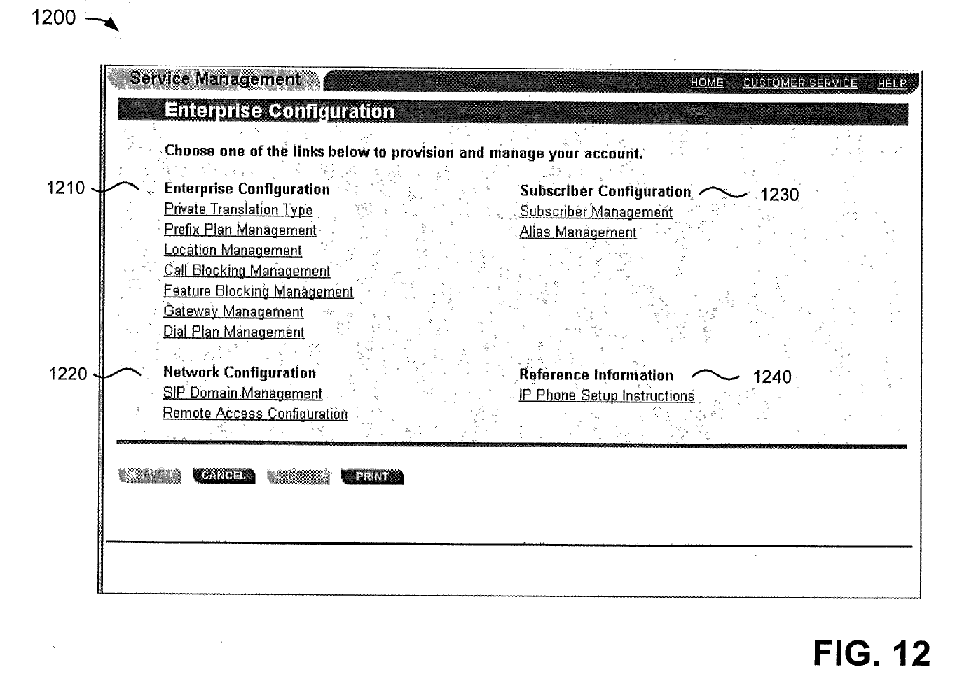

FIG. 12 illustrates an exemplary service management introductory screen 1200 that may be provided to the user by the network interface 320 in an implementation consistent with the present invention. As illustrated, the service management introductory screen 1200 allows the user to select from the following exemplary categories: Enterprise Configuration 1210, Network Configuration 1220, Subscriber Configuration 1230, and Reference Information 1240.

The Enterprise Configuration category 1210 provides the user with links for setting the private translation type (i.e., the way in which private calls are to be routed for the customer, such as via the network servers/redirect servers 810 or via traditional data access protocol routing) and performing prefix plan management, location management, call blocking management, feature blocking management, gateway management, and dial plan management functions. The Network Configuration category 1220 provides the user with links for performing SIP domain management and remote access configuration functions. The Subscriber Configuration category 1230 provides the user with links for performing subscriber management and alias management functions. The Reference Information category 1240 provides the user with IP phone setup instructions.

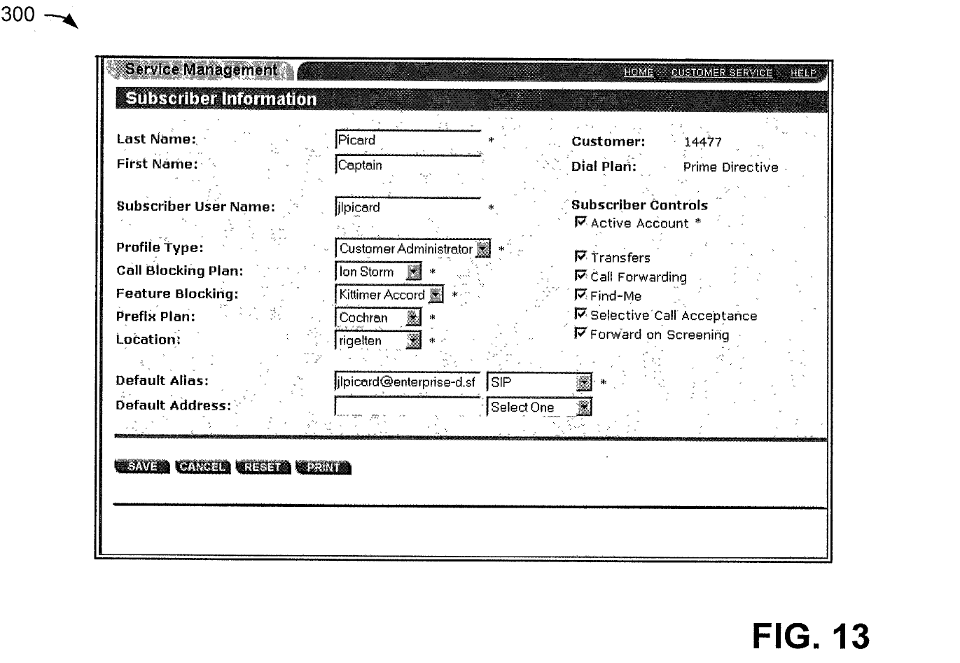

Upon selecting one of the links provided for the above-described categories, the network interface 320 provides the user with one or more screens for performing the desired function(s). FIGS. 13-21 illustrate exemplary screens that may be provided to a user by the network interface 320 in response to the user selecting links in the service management introductory screen 1200.

FIG. 13 illustrates an exemplary subscriber information screen 1300 that can be provided to the user by the network interface 320 in an implementation consistent with the present invention. This screen 1300 may be provided to the user in response to the user selecting the “subscriber management” link in FIG. 12. As illustrated, the subscriber information screen 1200 summarizes the user's service attribute profile and allows a user to enable/disable particular subscriber features. The subscriber information screen 1300 includes such information as the user's first and last name, a unique user name, customer number, the dialing plan that the user has established, the services that the user has activated (e.g., call transfer, call forwarding, etc.), the user's profile type, the active call blocking plan, the active feature blocking plan, the active prefix plan, the user's location, a default alias, and a default address.

The user name may be any unique name associated with the user. The profile type may indicate the user's profile (e.g., customer administrator, engineer, customer, etc.). The call blocking, feature blocking, and prefix plans indicate the currently active call blocking, feature blocking, and prefix plans, respectively, that have been established by the user.

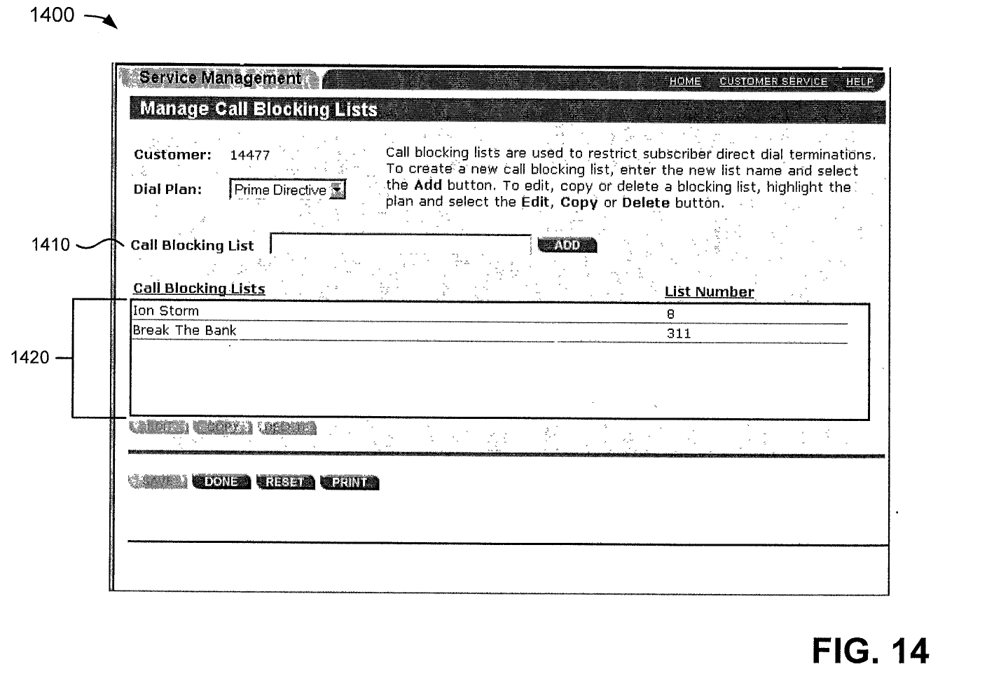

FIG. 14 illustrates an exemplary call blocking management screen 1400 that may be provided to a user by the network interface 320 in an implementation consistent with the present invention. This screen 1400 may be provided to the user in response to the user selecting the “call blocking management” link in FIG. 12. As illustrated, the call blocking management screen 1400 allows a user to add one or more call blocking lists 1410 or edit, copy, or delete an existing list 1420. Call blocking lists may be used to restrict subscriber direct dial terminations. For example, a subscriber may be restricted from establishing a connection to a certain number or range of numbers (e.g., 900 numbers). A user can add a new call blocking list by typing in a new list name into block 1410 and clicking the add button. The network interface 320 will then prompt the user to enter one or more call blocking rules for this new call blocking list. An exemplary rule may be to restrict calls to 900 numbers.

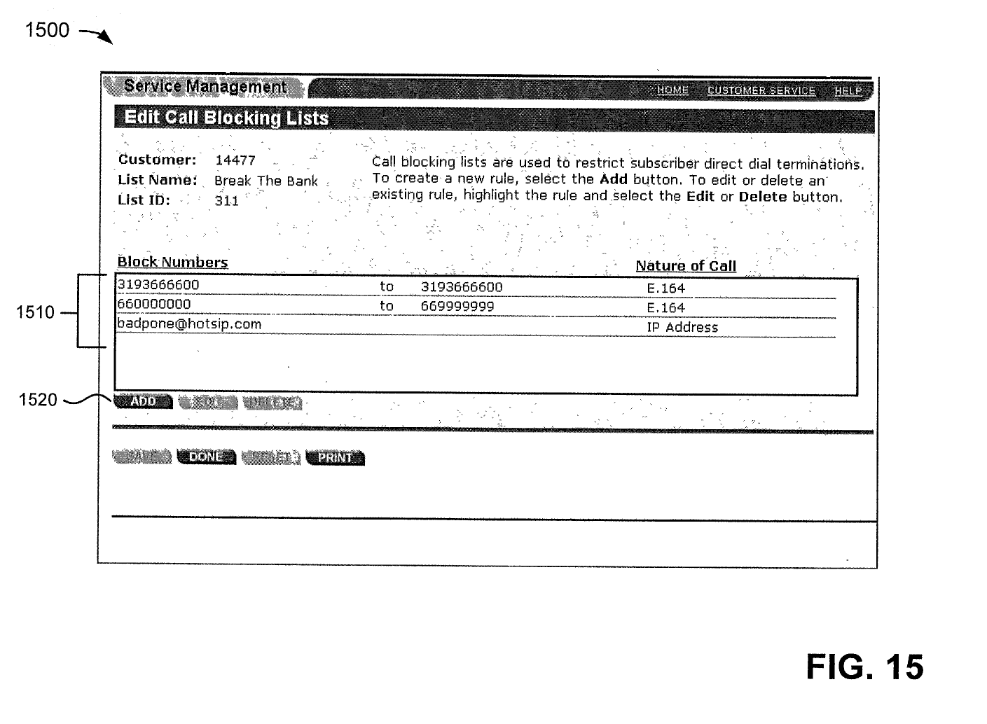

The user may edit, copy, or delete an existing list by selecting the list from block 1420 and selecting the appropriate button. Assume that the user selects the “Break The Bank” list from block 1420. The network interface 320 may provide the user with the exemplary screen illustrated in FIG. 15. FIG. 15 illustrates an exemplary call blocking list editing screen 1500 that may be provided to a user by the network interface 320 in an implementation consistent with the present invention. As illustrated, the call blocking list editing screen 1500 displays the call blocking rules 1510 that have already been established by the user. The rules may include one or more single telephone numbers, a range of telephone numbers, or one or more IP addresses.

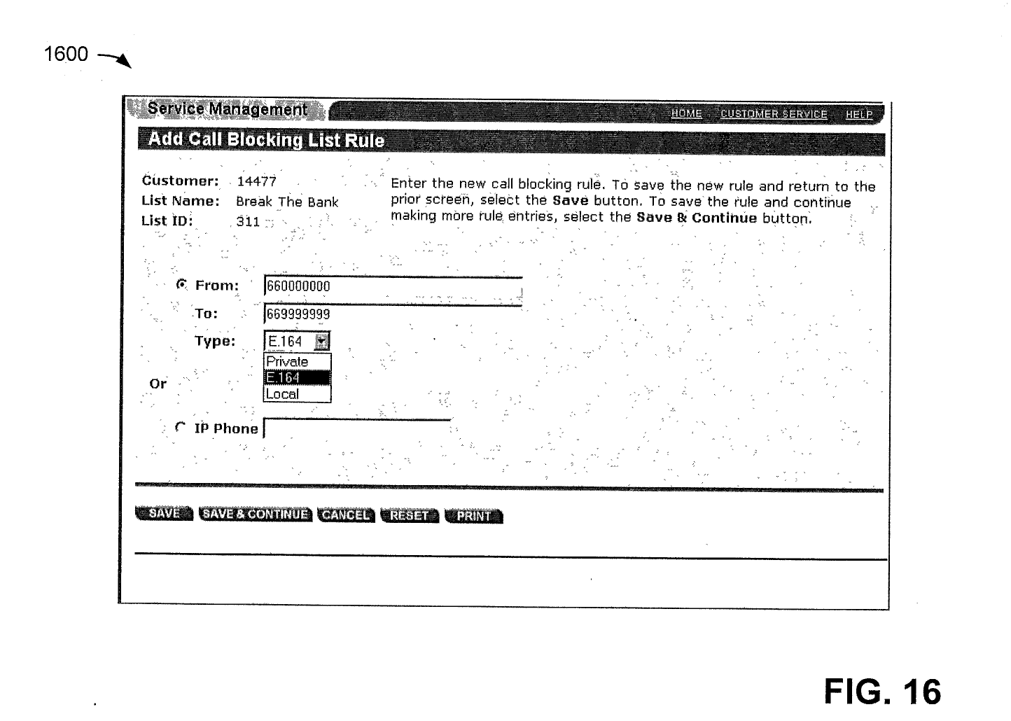

To add a new rule to the Break The Bank list, the user may select the ADD button 1520 by, for example, clicking on it. FIG. 16 illustrates an exemplary call blocking list addition screen 1600 that may be provided to a user by the network interface 320 in an implementation consistent with the present invention. As illustrated, the exemplary screen 1600 allows the user to enter a single telephone (e.g., Private, E.164, or Local) number, a range of telephone numbers, or a single IP telephone address to which calls are to be blocked. In the exemplary screen 1600 illustrated in FIG. 16, the user has chosen to block the range of E.164 numbers from 660000000 to 669999999.

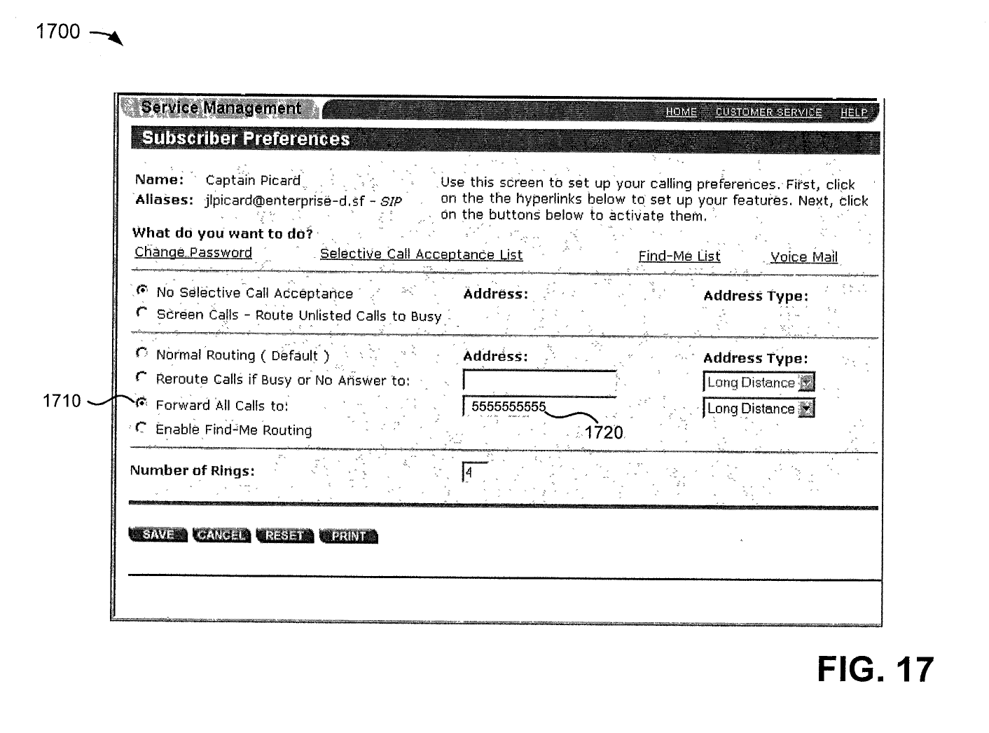

FIG. 17 illustrates an exemplary subscriber preferences screen 1700 that may be provided to a user by the network interface 320 in an implementation consistent with the present invention. Via this screen 1700, the user may set up his/her calling preferences, such as change his/her password, establish a selective call acceptance list or a find-me list, or set up or change his/her voice mail options. The user may also enable call screening, normal call routing, specify a destination for rerouting calls if a busy or no answer state has been encountered, forward calls to a destination number, or enable find-me routing. In the exemplary screen 1700 illustrated in FIG. 17, the user has enabled call forwarding 1710 and has entered a long distance telephone number (i.e., 5555555555) in block 1720 to which calls are to be routed.

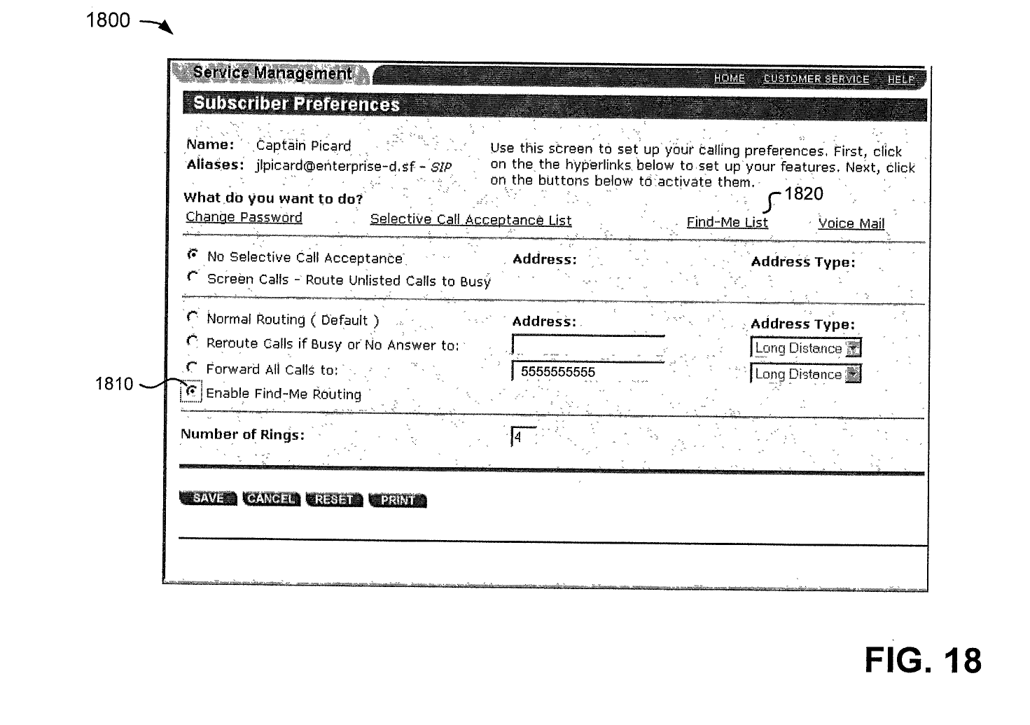

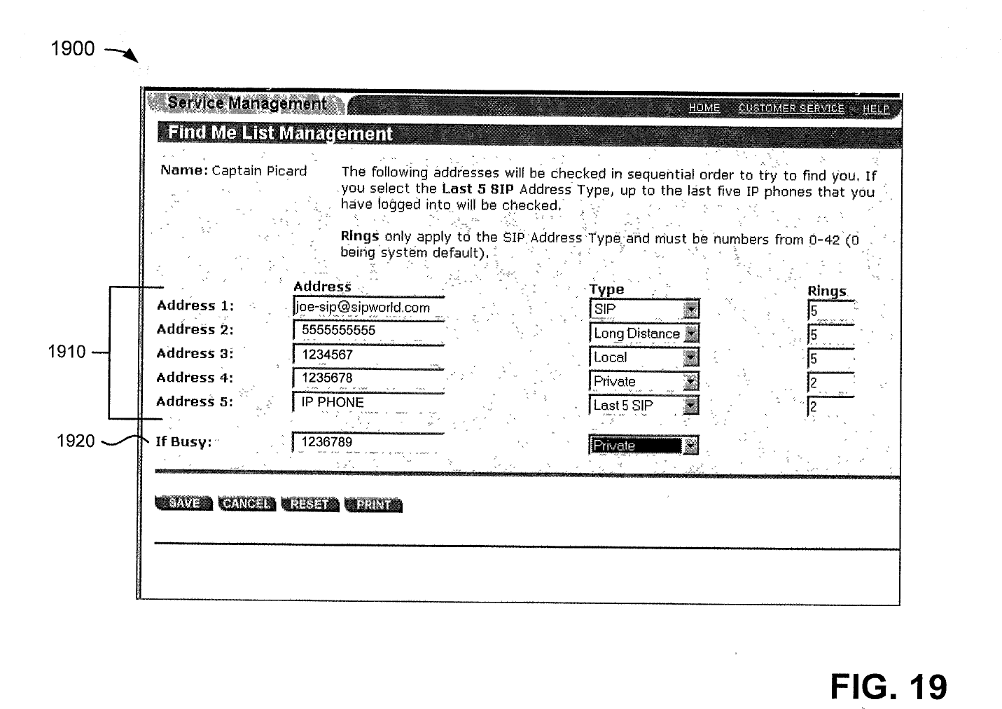

In the exemplary screen illustrated in FIG. 18, the user has enabled find-me routing 1810. Using find-me routing, the user can specify a sequential list of numbers (or addresses) to be tried in order to route the call to the user. The user's find-me list can be edited by selecting the Find-Me List link 1820. FIG. 19 illustrates an exemplary find-me list management screen 1900 that can be provided to the user by the network interface 320 in an implementation consistent with the present invention.

As illustrated, the management screen 1900 allows the user to enter a group of addresses (numbers) 1910 in order of preference that the user wishes the system to use in routing calls to the user. Five addresses are provided for simplicity. A typical find-me list management screen may provide more or fewer number of addresses. With each address entry 1910, the user must specify the type of destination device with which the address corresponds. For example, the first entry (i.e., joe-sip@sipworld.com) corresponds to a SIP telephone number. The user may also enter an address in block 1920 to which calls are to be routed in the event that an attempt to reach one of the addresses listed in block 1910 results in a busy signal. In the example illustrated in FIG. 19, the user has entered the private number “1236789.”

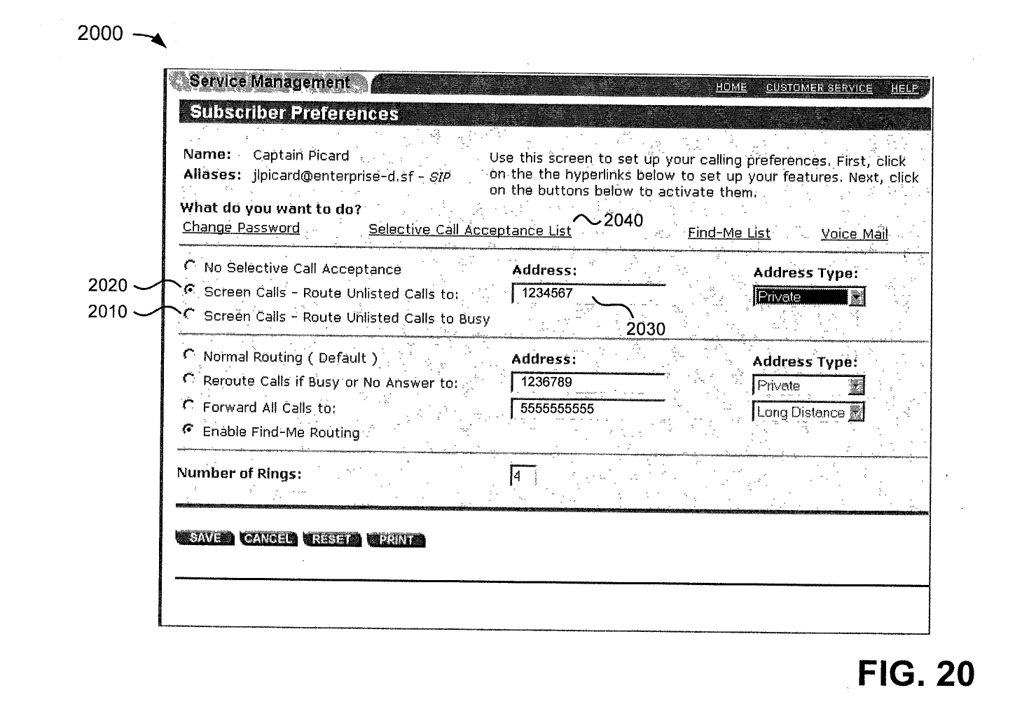

As noted above with respect to FIG. 17, the user may also enable call screening. This is illustrated in FIG. 20. In such a situation, the user may define a call acceptance list (i.e., a list of address for which calls are to be forwarded to the user). The user may choose to have unlisted calls (i.e., those calls associated with addresses that are not in the user's defined acceptance list) provided a busy signal 2010 or routed to a destination address 2020 by entering the destination number in block 2030. As illustrated in FIG. 20, the user wishes to have unlisted calls routed to the private number “1234567.”

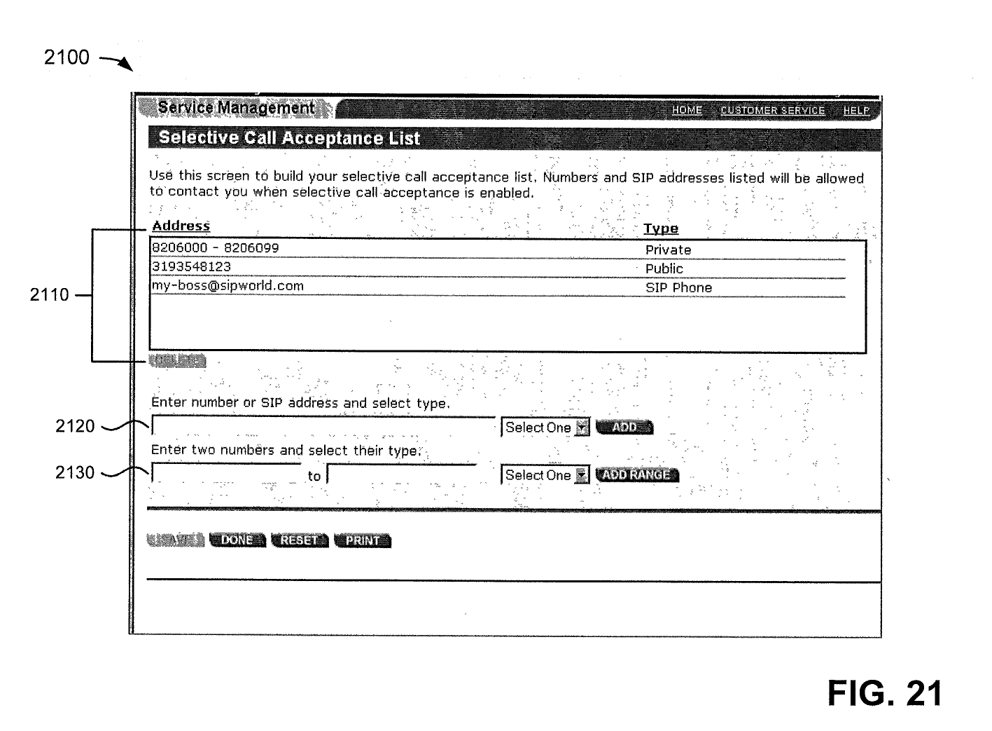

To edit a call acceptance list, the user may select the Selective Call Acceptance List link 2040. The network interface 320 may then provide the user with the exemplary screen 2100 illustrated in FIG. 21. Via screen 2100, the user may delete an existing address 2110, enter a single telephone number or SIP address 2120, or enter a range of numbers 2130 to add to the call acceptance list.

The screens illustrated in FIGS. 12-21 have been provided by way of example. It will be appreciated that the network interface 320 may provide the user with similar (or different) screens for managing other services of the IP communications network.

Returning to FIG. 10, the network interface 320 receives any modifications (e.g., additions, cancellations, and/or updates) made by the user to IP communications network service attributes [act 1050] and transmits this data to the process management system 310. The process management system 310 transmits the new data to the warehouse and the ODS of database 331. The ODS may validate, process, and store the data [act 1060] and forward a copy of the data to the redirect server 810, via the process management system 310, for storage in database 815 [act 1070]. In this way, the ODS acts as a superset of the redirect server 810, containing both an exact copy of the data stored at the redirect server 810 and additional attributes needed to control and maintain the data within the OSS 130.

The network server/redirect server 810 may direct calls to the appropriate gateway 820 or 830 based on this data. In this manner, changes made by a user to IP communications network service attributes are made available to the user in substantially real time.

### Conclusion

Implementations consistent with the present invention provide an operational support system that allows users to update attributes associated with IP communications network services, such as VoIP services, via a web-based interface. The operational support system makes changes to the service attributes available in substantially real time.

The foregoing description of exemplary embodiments of the present invention provides illustration and description, but is not intended to be exhaustive or to limit the invention to the precise form disclosed. Modifications and variations are possible in light of the above teachings or may be acquired from practice of the invention. For example, it will be appreciated that the present invention can be implemented in hardware, software, or a combination of hardware and software. Thus, the present invention is not limited to any specific combination of hardware circuitry and software.

Moreover, while a series of acts has been described with respect to FIG. 10, the order of the acts may vary in other implementations consistent with the present invention. In addition, non-dependent acts may be performed in parallel.

No element, act, or instruction used in the description of the present application should be construed as critical or essential to the invention unless explicitly described as such. Also, as used herein, the article “a” is intended to include one or more items. Where only one item is intended, the term “one” or similar language is used.

The scope of the invention is defined by the claims and their equivalents.

What is claimed is:

1. A method for updating Internet Protocol (IP) communications network service attributes, comprising:
receiving at least one modification to an IP communications network service attribute from a user;
modifying a first record in a database based on the received at least one modification;
transmitting the at least one modification from the database to a redirect server associated with the IP communications network; and
updating a second record, corresponding to the first record, in the redirect server based on the at least one modification, the updated second record being available in substantially real time.

2. The method of claim 1 further comprising:
using the updated second record, via the redirect server, for processing a call to the user.

3. The method of claim 1 wherein the IP communications network service attribute includes an attribute related to one of follow me, call blocking, call forwarding, voice mail, conference calling, single line extension, call screening, quality of service, class of service, dial-plan restrictions, dynamic registration, secondary directory number, and call transfer processing.

4. The method of claim 1 wherein the user includes a customer.

5. The method of claim 1 wherein the user includes at least one of an engineer, an account person, and an order entry person.

6. The method of claim 1 wherein the updating includes:
updating the second record in a database associated with the redirect server.

7. The method of claim 1 wherein the database is an operational data store.

8. The method of claim 7 wherein the receiving includes:
receiving the at least one modification via a web-based interface.

9. The method of claim 1 wherein the IP communications network service attribute relates to one of enterprise configuration, network configuration, and subscriber configuration.

10. The method of claim 1 wherein the IP communications network service attribute relates to one of private call routing, prefix plan management, location management, call blocking management, feature blocking management, gateway management, and dial plan management.

11. The method of claim 1 wherein the IP communications network service attribute relates to one of session initiation protocol (SIP) domain management and remote access configuration.

12. The method of claim 1 wherein the IP communications network service attribute relates to subscriber account management.

13. A system for updating service attributes associated with an Internet Protocol (IP) communications network, comprising:
a network interface configured to:
receive at least one update to one of the service attributes from a user via a data network, and
forward the at least one update;
an operational data store configured to:
receive the at least one update from the network interface,
store the at least one update, and
forward the at least one update; and
a redirect server, associated with the IP communications network, and configured to:
receive the at least one update from the operational data store, and
store the at least one update, the at least one update being available in substantially real time.

14. The system of claim 13 wherein the redirect server is further configured to:
use the at least one update for processing a call to or from the user.

15. The system of claim 13 wherein the service attribute includes an attribute related to one of follow me, call blocking, call forwarding, voice mail, conference calling, single line extension, call screening, quality of service, class of service, dial-plan restrictions, dynamic registration, secondary directory number, and call transfer processing.

16. The system of claim 13 wherein the user includes a customer.

17. The system of claim 13 wherein the user includes an engineer.

18. The system of claim 13 wherein the redirect server stores the update in a database.

19. The system of claim 13 wherein the data network includes an Internet.

20. The system of claim 19 wherein the network interface includes a web-based interface.

21. The system of claim 13 wherein the service attribute relates to one of enterprise configuration, network configuration, and subscriber configuration.

22. The system of claim 13 wherein the service attribute relates to one of private call routing, prefix plan management, location management, call blocking management, feature blocking management, gateway management, and dial plan management.

23. The system of claim 13 wherein the service attribute relates to one of session initiation protocol (SIP) domain management and remote access configuration.

24. A method for providing Internet Protocol (IP) communications network services, comprising:
providing a web-based interface to a user, the web-based interface allowing the user to update service attributes associated with the IP communications network;
receiving a change to a service attribute from the user;
storing the service attribute change in an operational data store;
transferring the service attribute change from the operational data store to a redirect server, the redirect server being associated with the IP communications network;
storing the service attribute change at the redirect server, the service attribute change being implemented in substantially real time; and
processing at least one call to the user based on the service attribute change.

25. The method of claim 24 wherein the service attribute relates to one of private call routing, prefix plan management, location management, call blocking management, feature blocking management, gateway management, and dial plan management.

26. The method of claim 24 wherein the service attribute relates to one of session initiation protocol (SIP) domain management and remote access configuration.

27. The method of claim 24 wherein the service attribute relates to subscriber account management.

28. A system for providing Internet Protocol (IP) communications network services, comprising:
means for providing a web-based interface to a user, the web-based interface allowing the user to update service attributes associated with the IP communications network;
means for receiving a change to a service attribute from the user;
means for storing the service attribute change in a database;
means for transferring the service attribute change from the database to a redirect server, the redirect server being associated with the IP communications network;
means for storing the service attribute change at the redirect server, the service attribute change being available in substantially real time; and
means for processing at least one call to the user based on the service attribute change.

29. The system of claim 28 wherein the service attribute relates to one of private call routing, prefix plan management, location management, call blocking management, feature blocking management, gateway management, and dial plan management.

30. The method of claim 28 wherein the service attribute relates to one of session initiation protocol (SIP) domain management, remote access configuration, and subscriber account management.
